(19) United States
(12) Patent Application Publication
(10) Pub. No.: US 2006/0225589 A1
(43) Pub. Date: Oct. 12, 2006

(54) Doctoring apparatus

(76) Inventors: Robert P. Johnson, Sutton, MA (US); Robert A. Reid, Charlton City, MA (US); Allen J. Brauns, Sturbridge, MA (US)

Correspondence Address: GAUTHIER & CONNORS, LLP, 225 FRANKLIN STREET, BOSTON, MA, 02110, US

(21) Appl. No.: 11/100,695

(22) Filed: Apr. 7, 2005

(51) Int. Cl. B41F 9/10

(52) U.S. Cl. 101/169

(57) ABSTRACT

A reciprocating doctor is provided for doctoring the cylindrical surface of a roll rotating about a first axis. The doctor includes a doctor back with a blade holder carrying a doctor blade. The doctor back has journals aligned on a second axis parallel to the first rotational axis of the roll. The journals are rotatably supported in sleeve bearings, and the sleeve bearings are in turn supported by diaphragms spaced along the second axis. The sleeve bearings are fixed axially on their respective journals, and the diaphragms have hub portions surrounding and fixed relative to the sleeve bearings, and peripheral portions surrounding the hub portions and fixed relative to a support structure. The diaphragms are configured to resiliently accommodate reciprocating movement of their hub portions and associated sleeve bearings relative to their peripheral portions and associated support structure. A first operating mechanism serves to rotate the doctor back about the second axis, and a second operating mechanism serves to impart reciprocating movement to the journals and their sleeve bearings along the second axis.

### BACKGROUND OF THE INVENTION

1. Field of the Invention

This invention relates generally to doctors used to doctor rolls in web handling and processing operations, and is concerned in particular with an improvement in doctors that are reciprocated in the cross machine direction during the doctoring process.

2. Description of the Prior Art

The journals of reciprocating doctors are conventionally supported for both axial and rotary motion in sleeve bearings. There are several disadvantages with such arrangements, especially when the doctor journals are subjected to heavy loads and only minimum axial movement is required, which is often the case with doctors employed in paper malting machines. Sleeve bearings normally have coefficients of friction ranging from 0.15 to 0.3, with 0.25 being the most common for a wide variety of sleeve materials. Using this value as an example, the force required to axially shift a journal within its sleeve bearing would be calculated as 0.25 multiplied by the applied load. Thus, a doctor with an applied load of 10,000 lbf would demand an elevated force on the order of 2500 lbf to effect axial reciprocating movement. Under these conditions, sleeve bearings exhibit significant wear over time, thus requiring expensive maintenance or replacement.

Linear ball bearings are also used to support doctor journals. Ball bearings offer less frictional resistance to axial movement of the journals. However, they require constant lubrication and can also exhibit significant wear over time, particularly when the axial displacement is relatively small, causing depletion of the lubricant at the contact zones between the balls and the bearing races.

### SUMMARY OF THE INVENTION

In accordance with the present invention, a reciprocating doctor is provided for doctoring the cylindrical surface of a roll rotating about a first axis. The doctor includes a doctor back with a blade holder carrying a doctor blade. The doctor back has journals aligned on a second axis parallel to the first rotational axis of the roll. The journals are rotatably supported in sleeve bearings, and the sleeve bearings are in turn supported by diaphragms spaced along the second axis. The sleeve bearings are fixed axially on their respective journals. The diaphragms have hub portions surrounding and fixed relative to the sleeve bearings, and peripheral portions surrounding the hub portions and fixed relative to a support structure. The diaphragms are configured to resiliently accommodate reciprocating movement of their hub portions and associated sleeve bearings relative to their peripheral portions and associated support structure. A first operating mechanism serves to rotate the doctor back about the second axis between an unloaded position at which the doctor blade is removed from roll surface, and a loaded position at which the doctor blade is applied to the roll surface. A second operating mechanism serves to impart reciprocating movement to the journals and their sleeve bearings along the second axis.

The reciprocating support provided by the diaphragms is both rigid in directions transverse to the second axis, and flexible in the axial direction. Axial movement is accommodated solely by the flexibility of the diaphragms, without sliding or rolling contact between coacting elements. This eliminates wear associated with axial motion.

These and other features and advantages of the present invention will now be described in greater detail with reference to the accompanying drawings, wherein:

### BRIEF DESCRIPTION OF THE DRAWINGS

FIG. 1 is an end view of a roll and an associated doctoring apparatus in accordance with the present invention;

FIG. 2 is a side elevational view of the apparatus shown in FIG. 1;

FIG. 3 is an enlarged end view of the bearing assembly supporting one of the doctor journals;

FIG. 4 is a sectional view taken along line 4-4 of FIG. 3;

FIG. 5 is a perspective view of the bearing assembly;

FIG. 6 is an exploded perspective view of some of the components of the bearing assembly;

FIG. 7 is a side view of a diaphragm;

FIG. 8 is a side view of a peripheral spacer element;

FIG. 9 is a side view of a hub spacer element.

FIG. 10 is a view showing the relationship of peripheral and hub spacer elements to an adjacent diaphragm;

FIG. 11 is an enlarged view of the circled area shown in FIG. 10.

### DETAILED DESCRIPTION OF PREFERRED EMBODIMENT

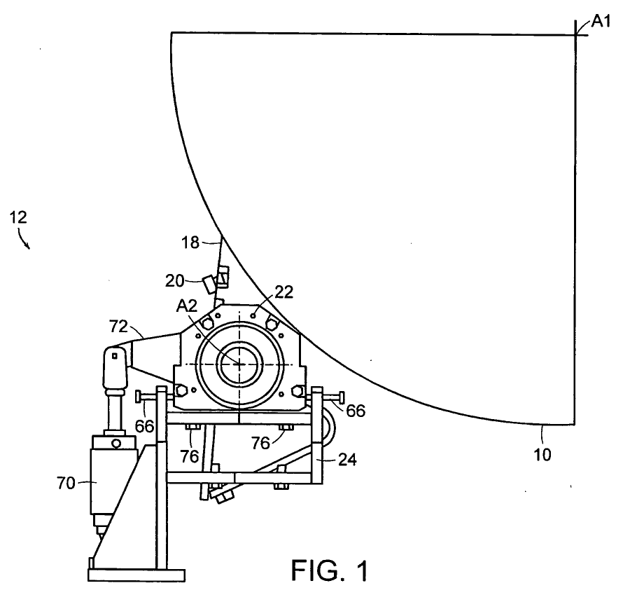

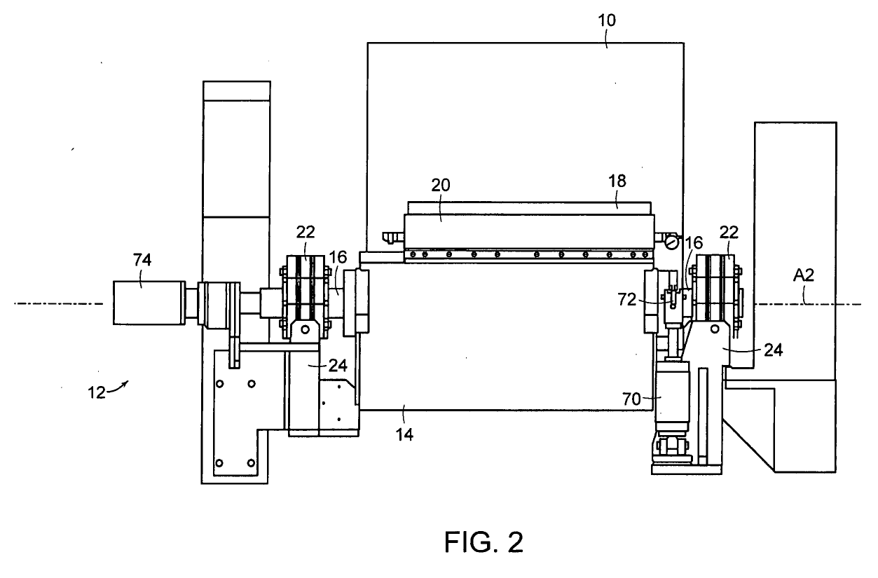

With reference initially to FIGS. 1 and 2, a doctoring apparatus for doctoring the cylindrical surface of a roll 10 is generally depicted at 12. The roll 10, which may for example be one of several in a paper making machine, is driven by means (not shown) for rotation about a first axis A₁.

The doctoring apparatus includes a doctor back 14 having journals 16 aligned on a second axis A₂ parallel to axis A₁. A doctor blade 18 is supported by a blade holder 20 carried on the doctor back. The journals 16 are supported in bearing assemblies 22 fixed to the support structure 24 of the machine.

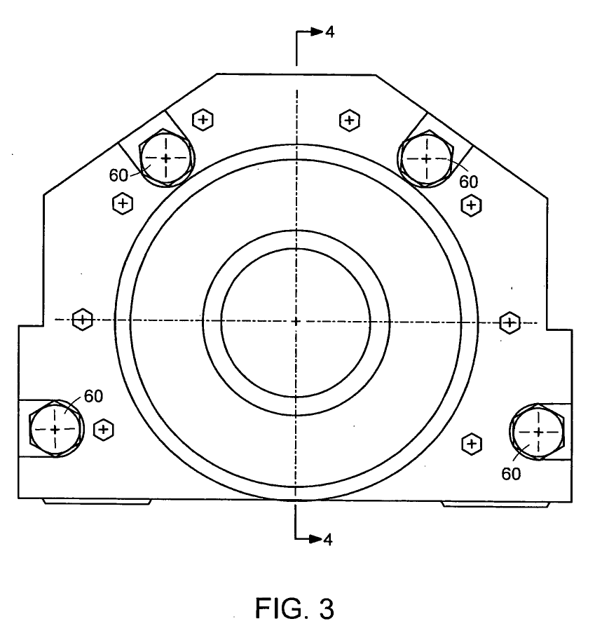

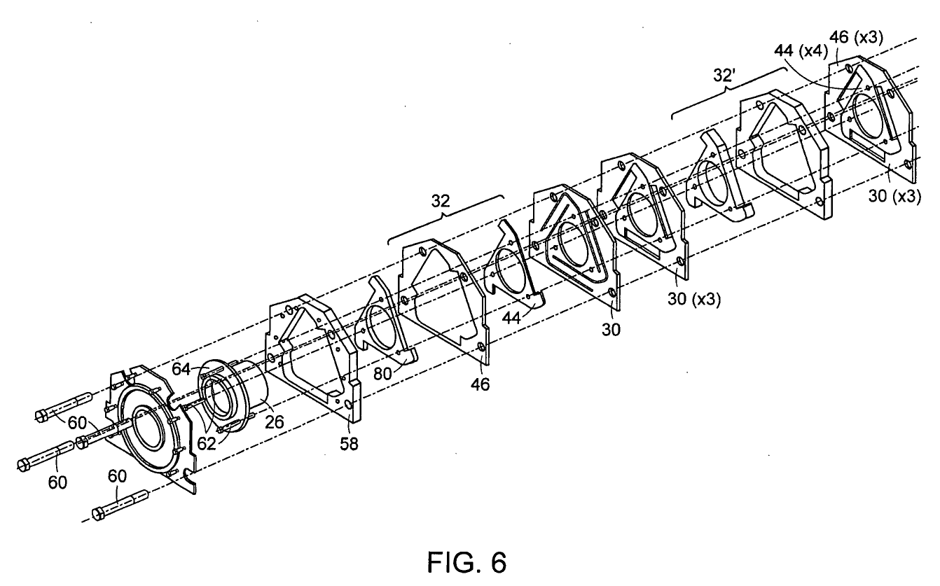

As can best be seen by further reference to FIGS. 3-6, the bearing assemblies 22 comprise sleeve bearings 26 supporting the journals 16 for rotation about the second axis A₂. The sleeve bearings are fixed axially to the journals between locating collars 28. Diaphragms 30 surround the sleeve bearings 26. The diaphragms 30 are spaced one from the other along the second axis, and comprise planar elements sandwiched between intermediate spacer assemblies 32.

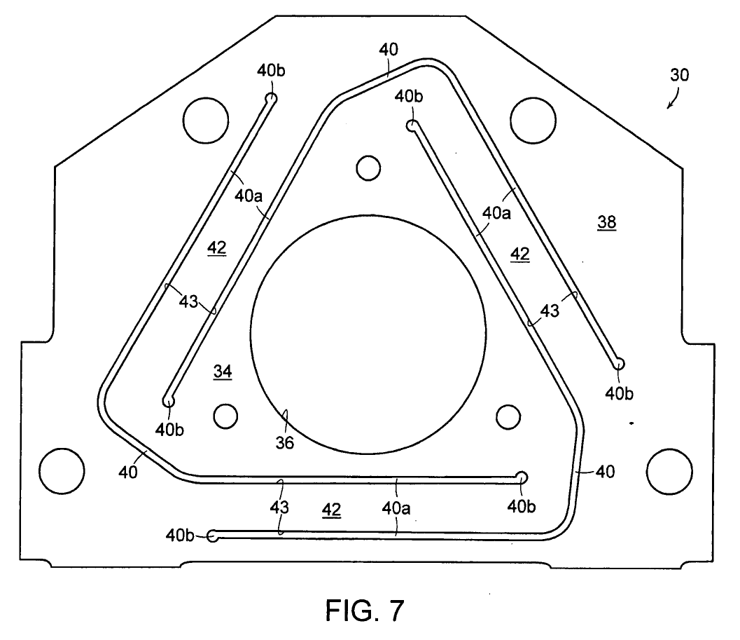

As shown in FIG. 7, the diaphragms 30 have hub portions 34 surrounding a bore 36, and peripheral portions 38 surrounding the hub portions 34. Generally V-shaped slots 40 are cut into the diaphragms. The slots 40 open towards the bore 36 and are arranged with parallel segments 40a bordering elongated flexure beams 42. The flexure beams have parallel side edges 43 and serve to connect the hub portions 34 to the peripheral portions 38. Preferably, the slots 40 are provided with enlarged terminal ends 40b.

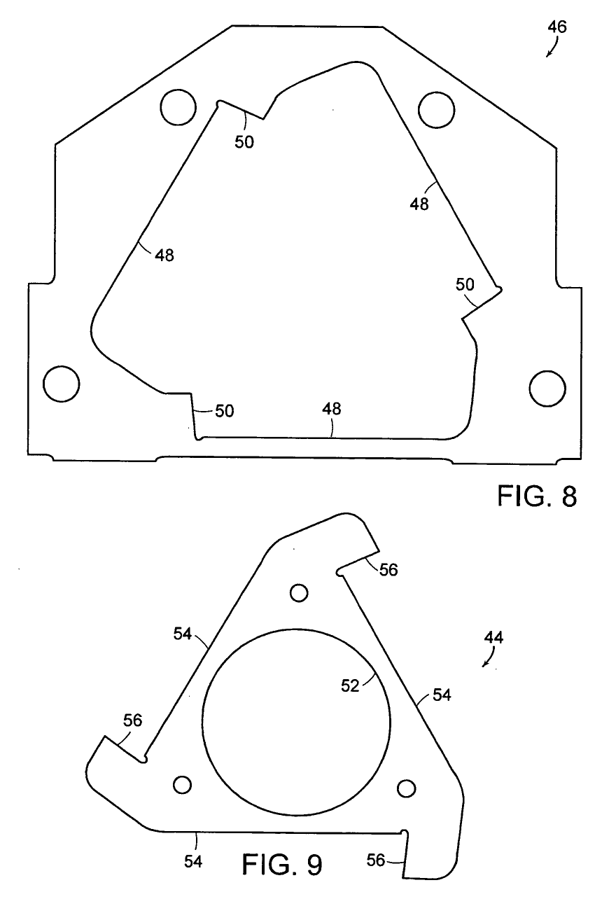

The intermediate spacer assemblies 32 each comprise a hub spacer element 44 surrounded by a peripheral spacer element 46. As shown in FIG. 8, the peripheral spacer element 46 has an outer profile matching that of the diaphragms 30, and an inner periphery defined in part by side edges 48 terminating at support edges 50.

As shown in FIG. 9, the hub spacer elements 44 have a central bore 52 and an outer periphery defined in part by angularly disposed side edges 54 terminating at support edges 56.

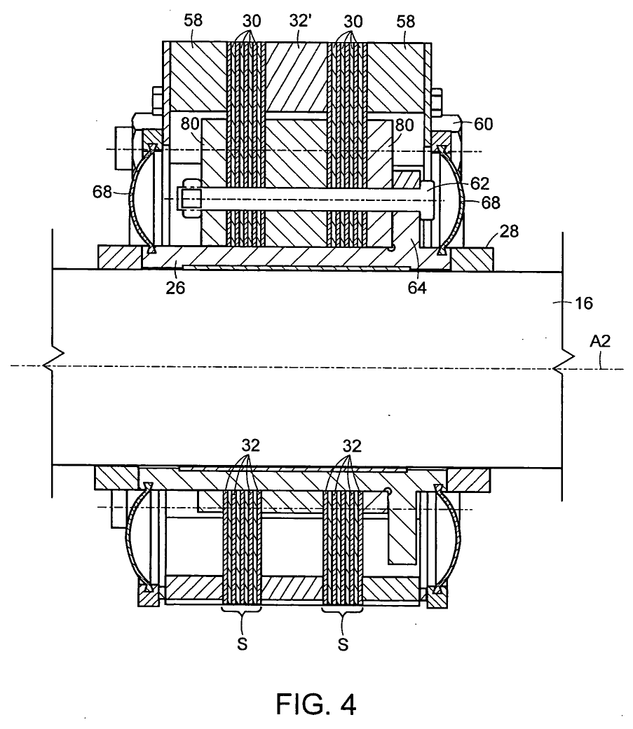

As shown in FIG. 4, the diaphragms 30 and intermediate spacer assemblies 32 are alternately assembled and sandwiched between end plates 58 and 80, with the entire assembly held together by cap screws 60 extending through aligned holes in the peripheral portions 38 of the diaphragms 30 and the peripheral spacers 46, and by smaller diameter cap screws 62 extending through aligned holes in the hub portions 34 of the diaphragms 30, the hub spacers 44, and an end flange 64 on the sleeve bearing 26.

One and perhaps more of the spacer assemblies, as indicated for example at 32′, may be thickened. The peripheral spacer of thickened spacer assembly 32′ and/or the thickened end plates 58 receive external cap screws 76 (shown in FIG. 1) which serve to fasten the bearing assembly to the machine support structure 24. Adjusting screws 66 aid in positioning the bearing assembly.

Flexible seal elements 68 may be incorporated at each end of the bearing assembly to prevent contaminants from infiltrating into the sandwiched components.

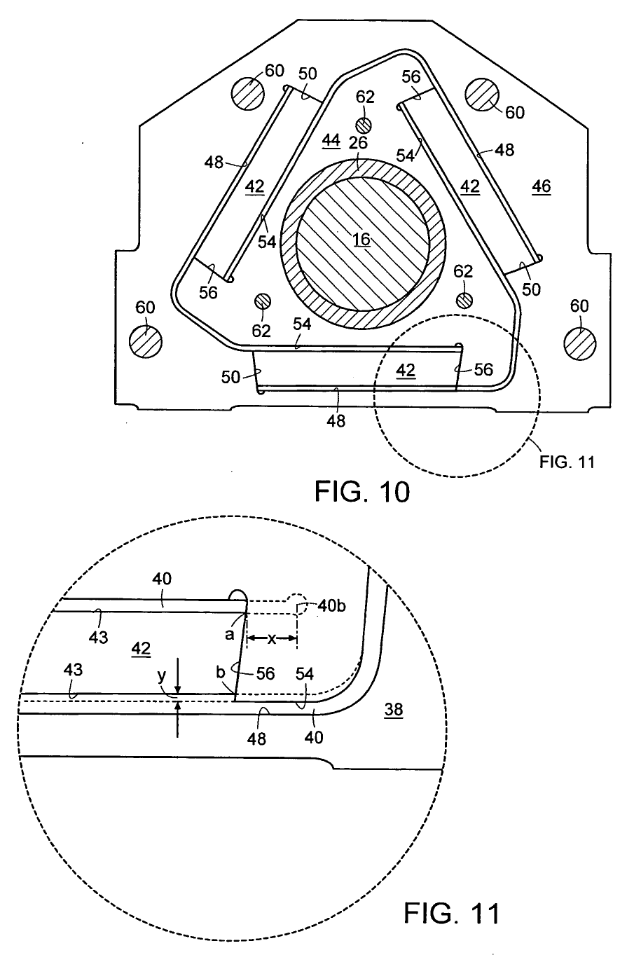

As can best be seen in FIG. 10, when the diaphragms 30 hub spacer elements 44 and peripheral spacer elements 46 are assembled, the side and support edges 48, 50 of the peripheral spacer elements 46 coact with the side and support edges 54, 56 of the hub spacer elements 44 to define spaces on opposite sides of the flexure beams 42.

The flexure beams 42 are thus free to flex about the support edges 50, 56 to accommodate axial movement of the journal 16, sleeve bearing 26 and hub spacer elements 44 relative to the peripheral spacer elements 46, the latter being fixed relative to the support structure 24.

With reference to FIG. 11, it will be seen that the enlarged terminal ends 40b of the slots 40 in the diaphragms 30 are located beyond the support edges 56 (and 50) by a distance “x” of at least about 0.2 inches. Further, support edges 50, 56 extend transversely beyond the beam edges 43 by a distance “y” of about 25% of the widths of the slots 40 to thereby insure full support across the entire width of the beams, irrespective of minor variations in assembly tolerances. These dimensional relationships insure that during flexure of the beams, the stress across the beams from points “a” to “b” remains uniform and absent of stress concentration effects.

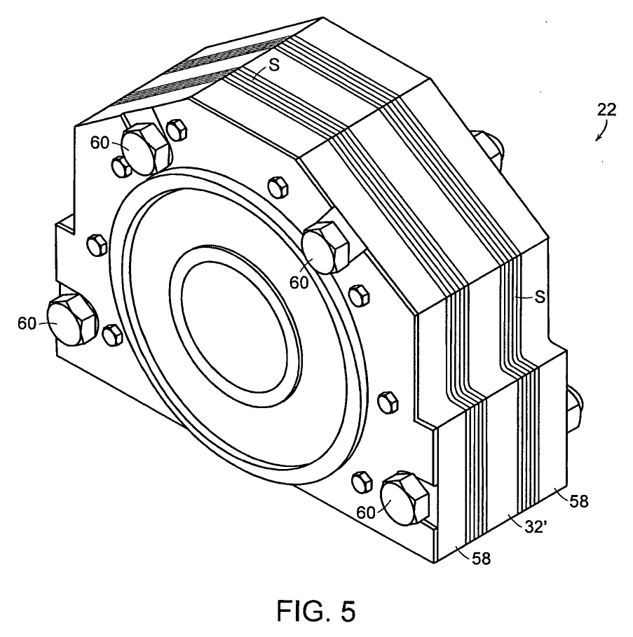

It will be seen from FIGS. 4 and 5 that a stack “S” of alternating diaphragms 30 and spacer assemblies 32 is located between each end plate 58 and the thickened central spacer assembly 32′. The number of stacks and thickened intermediate spacer assemblies is a matter of choice and can be varied to suit different sized bearings.

As shown in FIGS. 1 and 2, a piston-cylinder unit 70 is connected between the machine frame structure 24 and a crank arm 72 projecting laterally from the doctor back 14. The piston-cylinder unit 70 in conjunction with arm 72 serves as a first operating mechanism, for rotating the doctor back about axis A₂ between an unloaded position at which the doctor blade 18 is removed from the roll surface, and a loaded position as shown, at which the doctor blade is applied to the roll surface.

An oscillator 74 of known design, examples being pneumatic, hydraulic and mechanical linear motion devices, is connected to an end of one of the journals 16. The oscillator serves as a second operating mechanism for imparting axial reciprocating movement to the journals 16 and their sleeve bearings 26 along axis A₂. This axial reciprocating movement, which typically ranges up to ±⅜ inch about the stroke center, is accommodated exclusively by the resilient flexure of the beams 42 in the diaphragms 30. The diaphragms provide rigid support against transverse deflection of the journals under loads applied transversally with respect to axis A₂, yet the beams 42 offer relatively light resilient resistance to an oscillating force applied in the direction of axis A₂. Thus, in the example described previously, a relatively modest oscillating force on the order of only about 1500 lbf would be required to axially reciprocate the heavily loaded doctor.

We claim:

1. Apparatus for doctoring the cylindrical surface of a roll rotating about a first axis, said apparatus comprising:
a doctor back having journals aligned on a second axis parallel to said first axis;
a doctor blade carried by said doctor back;
bearings supporting said journals for rotation about said second axis;
a plurality of diaphragms spaced along said second axis at locations surrounding said bearings, said diaphragms having hub portions surrounding and fixed relative to said bearings and peripheral portions surrounding said hub portions and fixed relative to a stationary support structure, said diaphragms being resilient to accommodate reciprocating movement of said hub portions and said bearings relative to said peripheral portions and said support structure along said second axis;
first operating means for rotating said doctor back about said second axis between an unloaded position at which said doctor blade is removed from said cylindrical surface, and a loaded position at which said doctor blade is applied to said cylindrical surface; and
second operating means for imparting reciprocating movement to said bearings along said second axis.

2. The apparatus as claimed in claim 1 wherein said diaphragms comprise planar elements sandwiched between intermediate spacers.

3. The apparatus of claim 2 wherein said diaphragms have generally V-shaped slots with laterally spaced segments bordering flexure beams connecting said peripheral portions to said hub portions.

4. The apparatus as claimed in claim 3 wherein said intermediate spacers comprise hub spacer elements surrounded by peripheral spacer elements, said spacer elements being configured to define gaps therebetween aligned with said flexure beams, said gaps terminating at opposite ends at support edges extending transversally across said flexure beams, with end segments of said slots extending beyond said support edges.

5. The apparatus as claimed in claim 4 wherein said slots are provided with enlarged terminal ends.

6. The apparatus of claim 2 wherein multiple diaphragms and intermediate spacers are grouped in stacks separated by primary spacers, the axial thickness of said primary spacers being greater than that of said intermediate spacers.

7. The apparatus of claim 2 wherein the diaphragms and spacers associated with each bearing are tightly confined as an assembly between end plates.

8. The apparatus of claim 7 further comprising elastomeric seals extending between said bearings and said end plates.

9. The apparatus of claim 7 wherein said assembly has the capability of supporting resultant transverse loads of up to 30,000 lbf, with any accompanying transverse journal deflection being not more than 0.020 inches.

10. The apparatus of claim 4 wherein said support edges extend laterally beyond the edges of said flexure beams.
